(19) United States
(12) Patent Application Publication
(10) Pub. No.: US 2015/0375985 A1
(43) Pub. Date: Dec. 31, 2015

(54) ON-DEMAND FLUID DISPENSING SYSTEM

(71) Applicant: Glen Presley, Angola, IN (US)

(72) Inventor: Glen Presley, Angola, IN (US)

(21) Appl. No.: 14/320,553

(22) Filed: Jun. 30, 2014

(51) Int. Cl. B67D 7/62

(52) U.S. Cl. CPC B67D 7/62

(57) ABSTRACT

An on-demand fluid dispensing system including an electric motor driving a gear pump having flow paths including an intake line connected to a fluid reservoir and a discharge line having a manual shut-off valve at the end thereof whereas the shut-off valve has a RF transmitter that is energized when the shut-off valve is opened transmitting a signal to the RF receiver which sends an electrical signal to a relay which supplies power to an electric motor driving the pump and supplying fluid flow.

### BACKGROUND OF THE INVENTION

1. Field of the Invention

The present invention relates to fluid dispensing systems, and more particularly to an on-demand fluid dispensing system having a control at the dispensing end.

2. Description of the Related Art

On-demand fluid dispensing systems have been in use for many years to dispense oil or other non-compressible fluids. These systems are used to change fluids in vehicles, initial filling of new equipment and the general transfer of fluids. An on-demand system is very desirable since the fluid being dispensed is often located some distance from the point of dispensing. Up until the present time almost all of these systems have employed an air operated pumping system that consists of an air compressor to supply pressurized air, regulators and filters to control air pressure and to condition the air to remove moisture and contaminants from the air, an air operated pump to pump the fluid, plumbing to route the fluid to the desired location and a hose end valve or valve and meter to turn the system on and off. A meter can be used to turn the system on and off and to measure the fluid dispensed. The air pumps have consisted of an air operated reciprocating cylinder with the appropriate valve arrangement to produce the automatic reciprocating motion. The air pump is physically connected to a second cylinder that also reciprocates and is connected to the fluid sources that pumps the fluid being dispensed. The second cylinder has the appropriate valving to function as a pump. The pressure that can be obtained on the fluid being dispensed is determined by the air pressure to the air cylinder and the ratio of the areas of the air cylinder and the fluid-pumping cylinder. For example, if the air pressure is 100 PSI and the area ratio of the cylinders is 5 to 1, the maximum fluid pressure that can be developed would be 500 PSI.

This system becomes a demand type system since when the fluid flow is blocked the air pressure increases to the regulated pressure and the air cylinder stalls. When the pressure is relieved by opening the shut-off valve, the fluid pressure drops allowing the air pump to reciprocate pumping fluid. This is a very desirable feature since the operator only opens a valve to dispense fluid and closes the valve to stop fluid flow. Thus the system produces flow on-demand.

This prior art type system also has many disadvantages:
A large horsepower air compressor is required.
The air compressor and air pump both produce high noise levels.
If there is a plumping leak or breakage the pump will continue to operate causing a fluid spill. The pump will continue running until the reservoir is empty or the air supply is shut off.
This type system is also very inefficient due to the many conversions of power; electrical power is converted to pressurized air by the air compressor; the compressed air is converted to linear force by the air cylinder; and the linear force is converted to fluid pressure by the fluid cylinder. Each of these power conversions produce efficiency losses to the point that output power is often less than 10% of input power.
This system is sensitive to any moisture or contaminants in the air that can cause sticking in the air pump valving or wear in the air cylinder due to moisture and contamination.
The output flow in this system is inversely proportional to the fluid pressure. At no outlet pressure the system produces maximum flow and at maximum outlet pressure the system produces zero flow.
The outlet flow and discharge pressure pulsate due to the reciprocating nature of the pump. Each time the air cylinder reaches the end of the stroke and reverses the flow stops and the pressure drops. This causes pulsation in the system and is not desirable.
The installed cost of this type system is high due to the many components required to make a functional system. The need for a large air compressor if the air compressor is not required for other uses is a major cost.
The reliability of this type system is less than desirable due to contamination sensitivity of the air pump valving, seal wear of cylinders and the many components required in the system.

A second method to facilitate an on-demand system is covered by U.S. Pat. No. 6,662,970 patented by the present inventor. This system employs an electric motor driven pump, a reverse flow check valve on the pump outlet, a hose end shut-off valve, a relief valve to limit outlet pressure and a pressure switch positioned between the reverse flow check valve and the hose end shut-off valve. This system functions by trapping pressure greater than the pressure switch setting between the reverse flow check valve and the hose end shut-off valve. When the hose end shut-off valve is opened the trapped pressure drops below the pressure switch setting and power is supplied to the electric motor to thereby start the motor. When the hose end shut-off valve is closed the pressure builds in the pump discharge line until the pressure reaches the relief valve setting. The pressure switch setting must be lower than relief valve setting. When the pressure switch pressure setting is exceeded then power to the electric motor is cut off stopping the motor. Pressures greater than the pressure switch setting can be generated due to the inertia of the electric motor. Thus this system is an on-demand system since opening and closing the hose end shut-off valve will start and stop the pump. This system has the advantages over air operated systems of increased efficiency, noise reduction, very little pulsation and virtually constant flow rate.

This system also has disadvantages compared to the present invention as follows:
Any leakage of the outlet check valve will cause the system to kick on until trapped pressure builds above the pressure switch setting. Since liquids are non-compressible a very small leak will cause a large pressure drop. If the leakage is large enough the pump will continue to cycle on and off damaging the electric motor.
If there is an external leak in the system the pressure trapped in the system will drop and pump fluid until the trapped pressure is restored or the reservoir is emptied causing environmental problems.
The system plumbing must be sized to handle the pump flow rate at a system pressure drop less than the pressure switch setting. If the pressure drop is greater than the pressure switch setting the pump will continually cycle on and off. This is a major problem when replacing a system with existing plumbing.
Fluid viscosity will affect the pressure drop through the system and can cause the pressure drop through the system to exceed the pressure switch setting during cold weather.

### SUMMARY OF THE INVENTION

The present invention eliminates the use of compressed air for an on-demand system. This system consists of an electric motor driven pump that is connected to a fluid source. The outlet of the pump is connected to a hose end shut-off valve or shut-off valve employing a metering devise through the system plumbing. The shut-off valve contains a switch that supplies power to an RF transmitter, located in the shut-off valve or shut-off valve employing a metering devise that transmits a signal when the shut-off valve trigger is depressed. The transmitter signal is received by an RF receiver, which activates a relay to supply power to the electric motor driving the pump. When the shut-off valve trigger is released fluid flow is blocked and power to the RF transmitter is interrupted causing a loss of the signal to the receiver and interrupting the power to the electric motor. Since the motor is running and has inertia, there is fluid flow when the shut-off valve is closed. A relief valve is incorporated in the pump to bypass flow from the outlet of the pump back to the inlet side to prevent over pressurization. A back flow check valve is incorporated in the suction side of the pump to prevent fluid from draining from the pump when not running This check valve assures the pump will prime instantly when started and also eliminate any air in the system that may cause an error in the dispensing volume since air in the fluid system could cause an error reading in the hose end meter.

Advantages of present invention include:
Output flow is essentially constant with increasing pressure up to the relief valve setting.
The output flow is continuous and non-pulsating
The noise level is very low compared to an air operated system.
The system cost is much lower than air operated systems due to fewer components and the elimination of an air compressor.
The system is much more efficient than an air operated system. A 0.5 horsepower system will generate as much output as a 5 horsepower air driven system.
The system is more reliable since the problem of contaminated air is eliminated.
All ongoing maintenance is eliminated.
Installation costs are reduced since air lines, air filters, air regulators and lubricators are eliminated.
The electrical power required to operate the system is much less than an air operated system thereby reducing operating costs.
The system will function with existing undersized plumbing. If the pressure drop through the system is greater than the relief valve setting some flow will bypass through the relief valve.
Plumping leaks will not start the system and cause fluid spills as can occur with the air operated or pressure switch systems.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a symbolic schematic for an alternating current system; and

FIG. 2 shows a symbolic schematic for a direct current system.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

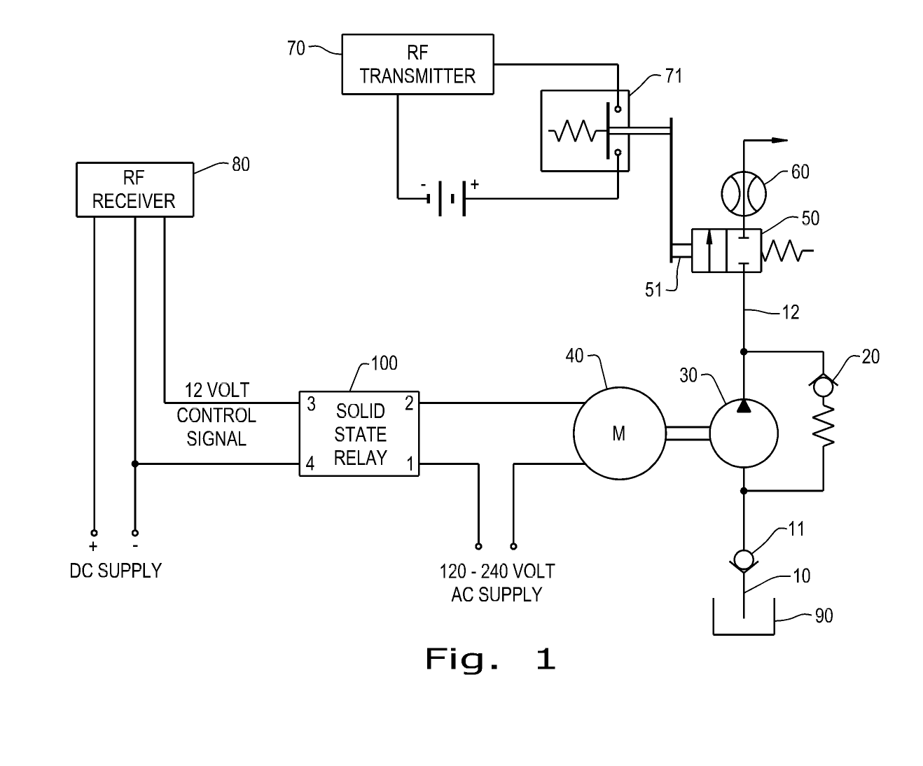

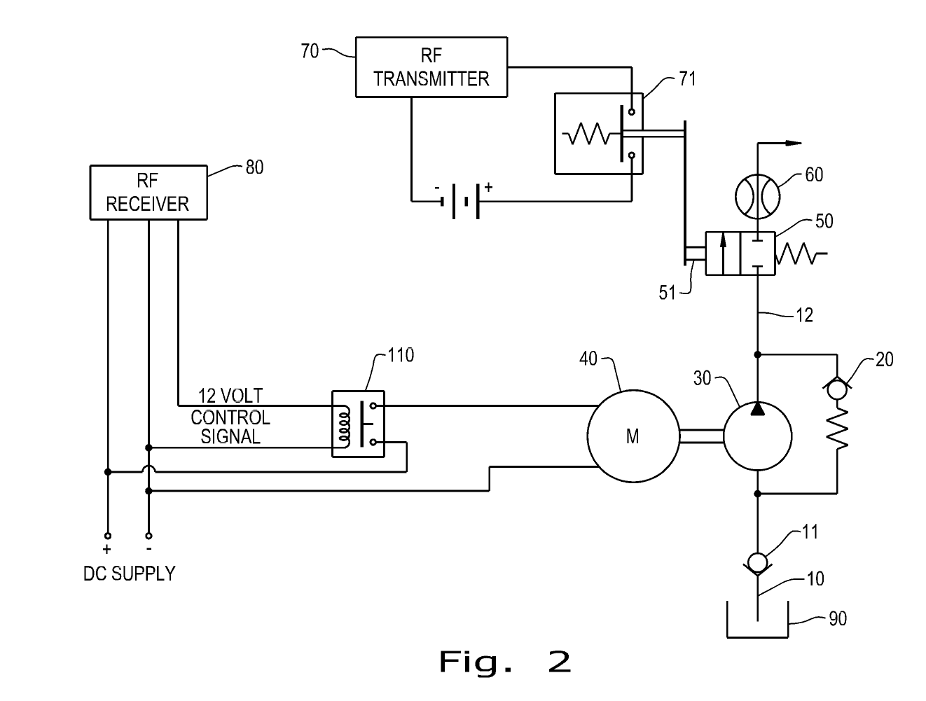

Referring now to the drawings, and more particularly FIGS. 1 and 2, there are illustrated improved systems of the present invention that include an electric motor 40 driving a pump 30. The pump 30 is mounted on a tank or reservoir 90 containing the fluid being dispensed. The pump 30 has a drop tube or suction pipe 10 that extends into the fluid. This drop tube or suction pipe 10 employs a check valve 11 that prevents fluid from flowing out of the suction pipe when pump 30 is not running so that pump 30 is always full of fluid. Pump 30 has an outlet that is connected through plumbing 12 to a shut-off valve 50 at the end of a dispensing hose. A metering devise 60 may also be installed with the shut-off valve 50 to measure the amount of fluid dispensed therethrough. An RF transmitter 70 is integral to shut-off valve 50 or the shut-off valve 50 and meter 60 combination. When a trigger 51 is depressed on shut-off valve 50, opening a flow path through the shut-off valve 50, a switch 71 is closed supplying power or a signal to transmitter 70. Transmitter 70 emits a signal that is received by receiver 80. When a signal is received by receiver 80, receiver 80 produces an output signal to a relay 100 or 110 closing the relay and supplying electrical power to motor 40 driving pump 30 thereby producing fluid flow. Receiver 80 can be integral to the motor or mounted remotely. When trigger 51 on shut-off valve 50 is released blocking fluid flow therethrough, switch 71 which supplies power to the transmitter 70 opens interrupting power to the transmitter 70 stopping the signal transmission from the transmitter 70 to the receiver 80. The receiver 80 signal to the relay 100 or 110 is interrupted which interrupts power to the electric motor 40 which stops driving pump 30. Since the motor 40 has inertia, a relief valve 20 is employed to bypass outlet flow back to the inlet side of the pump 30 to prevent over pressurization. Secondly, the relief valve 20 is set to limit the maximum outlet pressure to match the horsepower of electric motor 40.

It is to also be understood that the sending of the signal from transmitter 70 to receiver 80 may also be thought of as a flow signal and the lack of a signal being a shut-off signal. Either description is meant to incorporate the other. It is contemplated that receiver 80 may have multiple channels available, with one channel being selected to thereby allow the present invention to receive signals from multiple transmitters 70, operating on the selected channel, to thereby allow multiple valves 60 to dispense the fluid from the respective valve 60. For example, a repair/service shop may have multiple stations where it is desirable to dispense the fluid and each station would have a separate shut-off valve 50 and a separate transmitter 70, which can trigger the flow of the fluid by activating receiver 80 and thus activating motor 40. Another receiver 80 can be set to receive the flow signal on a different channel, thereby allowing a different fluid to be sent to different shut-off valves when triggered by transmitters 70 using the other channel.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An on-demand fluid dispensing system comprising:
an electric motor;
a pump driven by said electric motor, said pump having a flow path including intake and discharge lines;
a reservoir connected to the pump intake line;
a shut-off valve in the pump discharge line;
an RF transmitter integral to said shut-off valve, said RF transmitter being configured to transmit a signal when said shut-off valve is opened; and
an RF receiver configured to receive the signal transmitted from said RF transmitter and activate said electric motor dependent upon receipt of the signal.

2. The on-demand fluid dispensing system as set forth in claim 1, wherein said shut-off valve is a manually operated hose end shut-off valve containing said RF transmitter that transmits the signal when said shut-off valve is opened with a manual operation.

3. The on-demand fluid dispensing system as set forth in claim 1, further comprising a metering device, said shut-off valve being a manually operated hose end shut-off valve, said metering device being configured to provide information to an operator as to an amount of the fluid having flowed through the shut-off valve since said shut-off valve was opened.

4. The on-demand fluid dispensing system as set in claim 3, wherein said RF receiver stops receiving the signal and deactivates said motor dependent upon the lack of receipt of the signal.

5. The on-demand fluid dispensing system as set forth in claim 1, further comprising a relay, said RF receiver activating said electric motor by way of said relay.

6. The on-demand fluid dispensing system as set forth in claim 1, further comprising a relief valve coupled to said pump, said relief valve being configured to bypass an outlet flow from said pump back to an inlet side of said pump when the outlet flow is blocked by said shut-off valve.

7. The on-demand fluid dispensing system as set forth in claim 1, further comprising a back flow check valve positioned between said pump intake line and said reservoir.

8. The on-demand fluid dispensing system as set forth in claim 1, further comprising a relay configured to receive an electrical signal from said RF receiver to thereby start said electric motor.

9. An on-demand fluid dispensing system comprising:
a pump having a flow path from an inlet to an outlet;
a reservoir fluidically connected to the pump inlet;
a shut-off valve fluidically connected to the pump outlet;
a transmitter coupled to said shut-off valve, said transmitter being configured to transmit a flow signal when said shut-off valve is opened; and
a receiver configured to receive the signal transmitted from said transmitter and activate said pump dependent upon the flow signal.

10. The on-demand fluid dispensing system of claim 9, wherein said shut-off valve is a manually operated hose end shut-off valve containing said transmitter that transmits the flow signal when said shut-off valve is opened with a manual operation of said shut-off valve.

11. The on-demand fluid dispensing system of claim 10, further comprising a metering device configured to provide information to an operator as to an amount of the fluid having flowed through the shut-off valve since said shut-off valve was opened.

12. The on-demand fluid dispensing system of claim 11, wherein said pump is deactivated when said receiver stops receiving the flow signal.

13. The on-demand fluid dispensing system of claim 9, further comprising:
a relay, and
an electric motor configured to drive said pump, said relay being configured to provide electrical power to said electric motor when said receiver activates said relay.

14. The on-demand fluid dispensing system of claim 9, further comprising a relief valve coupled to said pump, said relief valve being configured to bypass an outlet flow from said pump outlet back to said pump inlet when the outlet flow is blocked by said shut-off valve.

15. The on-demand fluid dispensing system of claim 9, further comprising a back flow check valve positioned between said pump inlet and said reservoir.

16. A method of dispensing a fluid from an on-demand fluid dispensing system, the method comprising the steps of:
opening a shut-off valve;
transmitting a flow signal from a transmitter when said opening step is carried out; and
receiving said flow signal by a receiver and activating a pump dependent upon the receipt of the flow signal.

17. The method of claim 16, wherein said pump has a flow path from an inlet to an outlet, with a reservoir being fluidically connected to the pump inlet, said shut-off valve being fluidically connected to the pump outlet.

18. The method of claim 17, wherein said shut-off valve is a manually operated hose end shut-off valve containing said transmitter that transmits the flow signal when said shut-off valve is opened with a manual operation of said shut-off valve.

19. The method of claim 18, further comprising the step of metering the fluid passing through said shut-off valve using a metering device, said metering device being configured to provide information as to an amount of the fluid that has passed through said shut-off valve since said shut-off valve was opened.

20. The method of claim 18, further comprising the step of deactivating the pump when said receiver stops receiving the flow signal.
